(19) United States
(12) Patent Application Publication
(10) Pub. No.: US 2010/0222204 A1
(43) Pub. Date: Sep. 2, 2010

(54) METHOD OF PREPARING A CONTROLLED POROSITY GEOPOLYMER, THE RESULTING GEOPOLYMER AND THE VARIOUS APPLICATIONS THEREOF

(76) Inventors: Fabien Frizon, Villeneuve Les Avignon (FR); Christophe Joussot Dubien, Rochefort Du Gard (FR)

Correspondence Address: MILES & STOCKBRIDGE PC, 1751 PINNACLE DRIVE, SUITE 500, MCLEAN, VA, 22102-3833, US

(21) Appl. No.: 12/738,590

(22) PCT Filed: Oct. 15, 2008
(86) PCT No.: PCT/EP08/63865

§ 371 Date: Apr. 16, 2010

(30) Foreign Application Priority Data
Oct. 18, 2007 (FR) 0758409

(51) Int. Cl. B01J 29/04

(52) U.S. Cl. 502/60

(57) ABSTRACT

The present invention relates to a method for preparing a controlled porosity geopolymer with a step of dissolution/polycondensation of an aluminosilicate source in an activation solution comprising the following successive steps: (a) defining a characteristic of the porosity of the geopolymer to be prepared; (b) determining a value or an element for a parameter chosen from the total amount of water, the total amount of silica, the compensation cation, and the particle size distribution of the optional silicate components, which makes it possible to obtain the characteristic defined in step (a); and (c) selecting said value or said element predetermined in step (b). The present invention relates to a geopolymer capable of being prepared by said method and also to the various uses of said geopolymer.

### TECHNICAL FIELD

The present invention relates to the field of geopolymers and, more particularly, the field of controlled porosity geopolymers.

The present invention aims to provide a preparation method in which the main formulation parameters make it possible to simultaneously control the total porosity of the geopolymer and also its porous modes, i.e. microporous, macroporous and mesoporous, thus opening up the way for the porosity of these materials to be engineered.

The present invention also relates to the geopolymers capable of being obtained by said method, to the various uses thereof especially in the field of catalysis and filtration.

### PRIOR ART

For more than thirty or so years it has been known that bringing aluminosilicate materials into contact with a solution having a high pH may result, under chosen experimental conditions, in synthetic zeolites being obtained [1]. The crystalline nature and the degree of crystallinity of the latter depend, in particular, on the nature of the initial materials used and on the solution/solid weight ratio used.

The aluminosilicate sources which may be used for this synthesis are very varied, whether they are natural minerals (illite, stilbite, kaolinite, for example [2, 3]), calcined minerals (metakaolin [4-6], etc.) or substitution materials, mainly calcined by-products or residues of industrial exploitation (fly ash [7-12]). When the initial reactive material contains mainly silica and aluminium originating from an aluminosilicate source, when it is activated by strongly alkaline solutions and when the solid/solution weight ratio is low, the material obtained is an amorphous aluminosilicate inorganic polymer [13], [14] known as a “geopolymer” [15].

The geopolymer is prepared by activation of the aluminosilicate source starting from the solution of high pH. This preparation consists in mixing together the various components, then in storing the material obtained under defined conditions of temperature, pressure and relative humidity until the final geopolymer is obtained.

The precise reactions that lead to the formation of a geopolymer, also known as geopolymerization, are complex and still poorly understood. One simplified reaction mechanism is however generally accepted [37]: it mainly consists of a dissolution/polycondensation mechanism, the various steps of which take place simultaneously.

Initially, the solid grains of the aluminosilicate source are in suspension in the aqueous phase. At high pH, the dissolution of the aluminosilicate sources is rapid and leads to the appearance of chemical species (aluminates, silicates, aluminosilicates, etc.) in the activation solution, which phase may furthermore contain silicate species. This process consumes water.

The supersaturation of the solution leads to the appearance of a gel linked to the polycondensation of the oligomers in the aqueous phase. The size of the oligomers formed depends on the size of compensating cation [38].

While the polycondensation continues, internal reorganizations and rearrangements take place that lead to the formation of a three-dimensional aluminosilicate network.

It is already known that geopolymers develop a high porosity, which gives them, in particular, their advantage in applications as insulators. Geopolymers are also used as binders [16-20] in the formulation of building materials [21, 22], concretes or mortars [23, 24] and of fire-resistant materials [25-27]. Several methods of production are known [28, 29], enabling the use thereof on a building site or in the context of prefabrications [30, 31]. Moreover, just like standard calcium-silicon Portland cements, geopolymers can be used as a matrix for covering toxic waste or for rendering toxic waste inert [32-34].

As explained above, the porous nature of the geopolymers can make them a particularly advantageous support for various applications such as, for example, in catalysis or in filtration. Thus, there is a real need for a method for preparing geopolymers for the purpose of having, in a reproducible and controlled manner, a controlled porosity material, i.e. a material for which the porosity may be determined and pre-selected starting from the preparation of the formulation of said material.

### SUMMARY OF THE INVENTION

The present invention makes it possible to provide a solution to the need presented above and consists of a method that makes it possible to obtain geopolymers as monolithic materials, the porosity of which may be controlled starting from their formulation.

Indeed, the results obtained by the inventors have made it possible to develop a method by virtue of which the porosity of the material is as well controlled in the macroporous zone as in the mesoporous zone, said control applying as much to the total porosity of the material as to the pore distribution of the latter.

The term “geopolymer” is understood within the context of the present invention to mean an amorphous aluminosilicate inorganic polymer. Said polymer is obtained from a reactive material containing essentially silica and aluminium, activated by a strongly alkaline solution, the solid/solution weight ratio in the formulation being low, in particular below 0.6 and, advantageously, below 0.5. The structure of a geopolymer is composed of an Si—O—Al network formed from tetrahedra of silicates (SiO₄) and of aluminates (AlO₄) linked at their apexes by sharing oxygen atoms. Within this network are one (or more) charge compensating cation(s) also known as compensation cation(s). These cations, symbolized hereinafter by the letter M, make it possible to compensate for the negative charge of the AlO₄⁻ complex. The geopolymer prepared according to the method of the present invention may be microporous, macroporous or mesoporous. Advantageously, it is a macroporous or mesoporous geopolymer.

Remember that, according to the International Union of Pure and Applied Chemistry (IUPAC) [35], the following terms are described:
microporous: a material for which the diameter of the pores (dp) is less than 2 nm;
mesoporous: a material such that 2<dp<50 nm; and
macroporous: a material for which the diameter of the pores is greater than 50 nm.

The present invention puts forward the possibility of defining the porosity of the geopolymer by the formulation, more particularly in macroporous and mesoporous domains. Furthermore, the method that is the subject of the present invention is noteworthy since an identical porosity of the final material may originate from several different initial formulations.

Formulating a geopolymer comes down to choosing [5, 10, 36]:

(1) an aluminosilicate source;

(2) one or more compensation cation(s);

(3) an activation solution of high pH, characterized in particular by its amount of water and the amount of soluble silicates that it may possibly contain.

The pore properties of the material are influenced by the specific choices of the species selected for the preparation. Thus, a judicious determination of all of the formulation and processing parameters makes it possible to control a priori several properties linked to the porosity of the geopolymer.

Thus, the studies of the inventors have made it possible to show that three fundamental properties of the porous materials may thus be predefined by an appropriate choice during the preparation thereof:

(a′) the total porosity;

(b′) the class of porosity (macroporosity, mesoporosity or microporosity); and

(c′) the pore distribution and especially the pore size distribution in a given class.

Thus, within the context of the present invention, the expression “controlled porosity” is understood to mean the control of the total porosity, of the class of porosity and/or of the pore distribution.

The present invention is therefore characterized by a motivated choice of certain parameters starting from the formulation of the geopolymer to be prepared after having previously defined the pore characteristics of said geopolymer.

The present invention therefore relates to a method for preparing a controlled porosity geopolymer comprising a step of dissolution/polycondensation of an aluminosilicate source in an activation solution that may optionally contain silicate components, said method comprising the following successive steps that consist in:

a. defining at least one characteristic of the porosity of the geopolymer to be prepared;

b. determining a value or an element for at least one parameter chosen from the total amount of water, the total amount of silica, the compensation cation, and the particle size distribution of the optional silicate components, which makes it possible to obtain the characteristic defined in step (a); and

c. selecting said value or said element predetermined in step (b).

Step (a) of the method according to the present invention consists in defining at least one characteristic chosen from the group constituted by the total porosity, the class of porosity and the pore distribution such as the pore size distribution in a given class. Advantageously, at least two of these characteristics and, more particularly, the three characteristics are defined in step (a).

Step (b) of the method according to the present invention may be carried out in various ways.

Advantageously, this step consists in testing various values (or various elements) for at least one parameter from among the parameters previously listed and determining the value (or the element) that makes it possible to obtain at least one characteristic defined in step (a).

As a variant, step (b) of the method according to the invention may consist in identifying the value (or the element) that makes it possible to obtain at least one characteristic defined in step (a) on the basis of data previously obtained and in particular accessible to a person skilled in the art in scientific publications or patent applications.

It may be necessary to repeat step (b) several times and in particular for each pore characteristic defined.

More particularly, the present invention relates to a method for preparing a controlled porosity geopolymer comprising a step of dissolution/polycondensation of an aluminosilicate source in an activation solution that may optionally contain silicate components, said method comprising a step that consists in selecting:
a predetermined value for the total amount of water and/or for the particle size distribution of any silicate components in order to obtain a geopolymer for which the water-accessible porosity is between around 15% and around 65%. Advantageously, the water-accessible porosity of the geopolymer is around 15%, around 20%, around 25%, around 30%, around 35%, around 40%, around 45%, around 50%, around 55%, around 60% or around 65%;
a predetermined value for the total amount of silica in order to obtain a geopolymer having a unimodal microporosity, mesoporosity or macroporosity; and/or
a predetermined element corresponding to one particular compensation cation in order to obtain a geopolymer for which the pore distribution is more or less extensive.

The expression “around X %” is understood to mean X %±2%.

Indeed, the studies of the inventors have made it possible to show that the total porosity of the geopolymers may be controlled by modifying the formulation parameters of these materials, in particular the water content. Thus, without being limited to any one theory, the amount of water influences the total porosity of the geopolymer probably by conditioning:
the space initially separating the source aluminosilicate solid particles;
the porosity inside the gel that is linked to the production of water during the polycondensation;
the concentration of aluminates and silicates in solution, therefore the morphology of the gel.

The amount of water may especially be set via the H₂O/M₂O molar ratio with H₂O corresponding to the sum of the amount, expressed in moles, of water present in the activation solution and of the amount, expressed in moles, of water possibly bound to the aluminosilicate source and M₂O corresponding to the molar amount of compensation cation oxide in the activation solution. A person skilled in the art may obtain and/or calculate these values, with no inventive effort, by using standard chemical analyses, such as weighing or X-ray fluorescence, of all of the reactants used. Thus, an increase in the H₂O/M₂O molar ratio makes it possible to increase the total porosity of the geopolymer thus obtained. By way of example and non-limitingly, the inventors have shown that an H₂O/M₂O molar ratio greater than 10, advantageously greater than 11 makes it possible to obtain a geopolymer for which the water-accessible porosity is greater than 50%.

The inventors have also demonstrated that the particle size distribution of the silicate components possibly present in the activation solution and in particular the median diameter or range of this particle size distribution influence the total porosity of the geopolymer thus obtained. Thus, the predetermined value for the particle size distribution of the optional silicate components is advantageously chosen from a predetermined value of the median diameter of the particle size distribution of the optional silicate components or a predetermined value of the range of the particle size distribution of the optional silicate components. On the one hand, the lower the median diameter of the silicate components used, the more the polymer obtained has a low water-accessible porosity. On the other hand, the lower the range of the particle size distribution of the silicate components, the more the pore distribution of the geopolymer obtained is centred about a low value and, consequently, the lower the total porosity of the geopolymer.

Thus, a person skilled in the art could obtain a geopolymer, for which the total porosity will be controlled by selecting either an appropriate amount of water, or silicate components that have a suitable particle size distribution in terms of median diameter and/or in terms of range of the particle size distribution, or an appropriate amount of water and silicate components that have a suitable particle size distribution in terms of median diameter and/or in terms of range of the particle size distribution.

Through the work of the inventors, it has also been demonstrated that the class of porosity (macropores, mesopores or micropores) may be chosen starting from the processing by selecting a suitable total concentration of silica.

Thus, starting from a set amount of water, the porous mode depends on the porosity specific to the gel. This comes down to modifying the polycondensation behaviour, for example by doping the amount of silicate monomers via addition of reactants into the activation solution. Moreover, the unreacted silica seems to also result in a steric hindrance of the residual aqueous pore space, therefore in a reduction of the porous mode of the material. It should be noted that, as explained previously, the particle size distribution of the silica used has an impact on the methods of hindrance and therefore on the porosity of the material.

The expression “amount of silica” is understood to mean the sum of the silica provided by the aluminosilicate source and of the silica optionally present in the activation solution. The SiO₂/M₂O molar ratio makes it possible to assess the total amount of silica, SiO₂, corresponding to the molar amount of silicon oxide provided by the aluminosilicate source and by the silica optionally present in the activation solution. As stated previously, a person skilled in the art may obtain and/or calculate these values, with no inventive effort, by using standard chemical analyses, such as weighing or X-ray fluorescence, of all of the reactants used. Thus, an SiO₂/M₂O molar ratio greater than 1 and especially greater than 1.1 makes it possible to obtain a geopolymer having a unimodal mesoporosity whereas an SiO₂/M₂O molar ratio of less than 1, especially of less than 0.9, in particular of less than 0.8 and, more particularly, of less than 0.7 makes it possible to obtain a geopolymer, having a unimodal macroporosity.

Finally, the pore distribution and especially the pore size in one pore range may also be predetermined via an appropriate formulation. A geopolymer having a unimodal porosity and, very particularly, a unimodal macroporosity or mesoporosity, for which the distribution of the pore volumes is more or less extensive, may be synthesized by choosing one or more suitable compensation cation(s). At set water and silica contents in the material, the size and the arrangement of the oligomers formed depends on the size of the compensating cations used. The distribution of the thus controlled porosity therefore appears to be a porosity intrinsic to the initial oligomeric structures.

The compensation cation is especially chosen from alkali materials, alkaline-earth metals and mixtures thereof. The term “mixture” is understood to mean mixtures of two or more alkali metals, mixtures of two or more alkaline-earth metals and mixtures of one or more alkali metals with one or more alkaline-earth metals. Among the alkali metals, lithium (Li), sodium (Na), potassium (K), rubidium (Rb) and caesium (Cs) are more particularly preferred. Among the alkaline-earth metals, magnesium (Mg), calcium (Ca), strontium (Sr) and barium (Ba) are more particularly preferred.

The amount of compensation cation(s) capable of being used within the context of the method of the present invention is between 0.1 and 10, especially between 0.5 and 5, in particular between 0.8 and 2, most particularly, relative to the molar amount of Al₂O₃. Advantageously, in the various formulations used within the context of the present invention, the amount of compensation cation(s) is chosen so that the M₂O/Al₂O₃ molar ratio is equal to 1.

Thus, by way of examples and within the context of the alkali metal compensation cations, the selection step consists in selecting a compensation cation from potassium, sodium and caesium in order to obtain a range of the pore distribution of the geopolymer containing potassium as the compensation cation that is less than the range of the pore distribution of the geopolymer containing sodium as the compensation cation, which is itself less than the range of the pore distribution of the geopolymer containing caesium as the compensation cation. On the basis of example IV in the experimental section below, a person skilled in the art will know how to determine, as a function of the compensation cation or of the mixture of compensation cations used, the influence on the porosity distribution without demonstrating particular inventive effort.

Any aluminosilicate source known to a person skilled in the art may be used within the context of the method of the invention. Advantageously, this aluminosilicate source is a solid source containing amorphous aluminosilicates. These amorphous aluminosilicates are especially chosen from natural aluminosilicate minerals such as illite, stilbite, kaolinite, pyrophyllite, andalusite, bentonite, kyanite, milanite, grovenite, amesite, cordierite, feldspar, allophane, etc.; calcined natural aluminosilicate minerals such as metakaolin; synthetic glass based on pure aluminosilicates; aluminous cement; pumice; calcined by-products or residues of industrial exploitation such as fly ash and glass furnace slags respectively obtained from the combustion of coal and during the conversion of molten iron ore in a blast furnace; and mixtures thereof.

The aluminosilicate source used within the context of the present invention is in a solid form and, advantageously, in the form of a powder or of a mixture of particles. These particles especially have a median diameter (d50) between 0.1 and 40 μm, in particular between 0.5 and 20 μm and, very particularly, between 1 and 10 μm. By way of example and non-exhaustively, when metakaolin is used as an aluminosilicate source, it is in the form of particles, the median diameter (d50) of which determined by laser particle size analysis is around 6 μm. As a reminder, particles of which the average diameter (d50) is 6 μm means that half of the particles have a diameter of less than 6 μm.

A person skilled in the art, at the moment of formulation, will know, without an inventive effort, how to calculate the amount of aluminosilicate source to be used as a function of the composition of the aluminosilicate source used and of the desired objective, i.e. of the properties desired for the geopolymer. Indeed, as a function of the desired properties, a person skilled in the art will know how to choose the values best suited for achieving this objective and therefore will know how to set the H₂O/M₂O and/or SiO₂/M₂O molar ratios.

The expression “activation solution” is understood within the context of the present invention to mean a strongly alkaline aqueous solution which may optionally contain silicate components. The expression “strongly alkaline” is understood to mean a solution for which the pH is greater than 9, especially greater than 10, in particular greater than 11 and, more particularly greater than 12.

The activation solution comprises the compensation cation or the mixture of compensation cations in the form of an ionic solution or of a salt. Thus, the activation solution is especially chosen from an aqueous solution of sodium silicate (Na₂SiO₃), of potassium silicate (K₂SiO₂), of sodium hydroxide (NaOH), of potassium hydroxide (KOH), of calcium hydroxide (Ca(OH)₂), of caesium hydroxide (CsOH) and sulphate, phosphate and nitrate, etc. derivatives thereof.

A person skilled in the art knows various ways of preparing such an activation solution either by diluting existing commercial compositions or by preparing it extemporaneously. A person skilled in the art also knows various ways for adjusting the pH to the desired value, where necessary.

The silicate components present in the activation solution may be not only the silicates provided by the silicates of the compensation cations present in the activation solution but also other silicates added to the activation solution. The latter are especially chosen from silica, colloidal silica and vitreous silica. It is therefore clear that the silicate components present in the activation solution are either solely the silicate(s) provided in the form of silicates of the compensation cations, or solely the silicate(s) added and chosen from silica, colloidal silica and vitreous silica, or a mixture of these two sources of silicates. The activation solution is prepared by mixing the various elements described previously which make it up. The mixture may be produced under a more or less intense stirring as a function of the nature of said elements.

By way of example and by using, as an aluminosilicate source, metakaolin, the chemical composition of which is given in Table 1 below, the solid/solution weight ratio is, within the context of the present invention, low, in particular below 0.6 and advantageously below 0.5. This weight ratio corresponds to the weight of solids (i.e. aluminosilicate source+compensation cations+silicate components) over the mass of solution (i.e. activation solution).

The method of preparing a controlled porosity geopolymer that is the subject of the present invention and, more particularly, the dissolution/polycondensation steps consists, firstly, in mixing the aluminosilicate source with the activation solution under a more or less intense stirring as a function of the nature of the aluminosilicate source and of the elements contained in the activation solution then in storing the material obtained under defined temperature, pressure and relative humidity conditions until the final geopolymer is obtained.

These various steps are carried out at a temperature between 20 and 120° C. and especially between 20 and 100° C. The reaction time until the controlled porosity geopolymer is obtained will depend on the temperature chosen from the range of temperatures above. Specifically, the closer the temperature is to ambient temperature, the longer the reaction time. It should be noted that the reaction time is also a function of the compensation cation(s) used. By way of examples, the reaction time could be between 5 minutes and 48 hours, especially between 1 and 42 hours, advantageously between 5 and 36 hours and, in particular, between 10 hours and 24 hours.

The person skilled in the art knows the optimal pressure and relative humidity conditions to be used, during these steps, as a function of the various reactants used (i.e. aluminosilicate source and elements present in the activation solution). By way of example and non-limitingly, the reaction is carried out under sealed conditions and under a pressure corresponding to atmospheric pressure.

The present invention also relates to a geopolymer capable of being prepared by the method of the invention and having a unimodal mesoporosity with 50% of the pores having an accessibility diameter determined by mercury porosity that extends over less than 5 nm (highly refined pore distribution), between 5 and 10 nm (broader pore distribution) or over more than 10 nm (extended pore distribution).

The present invention also relates to a geopolymer capable of being prepared by the method of the invention and having a unimodal macroporosity with 50% of the pores having an accessibility diameter determined by mercury porosity that extends over less than 10 nm (highly refined pore distribution), between 10 and 50 nm (broader pore distribution) or over more than 50 nm (extended pore distribution).

The present invention also relates to a catalyst support and/or support for separating chemical species comprising a geopolymer as defined previously and to the use of said geopolymer. All the uses known to a person skilled in the art using a geopolymer and especially the uses described in the prior art mentioned above are envisaged within the context of the present invention. The present invention relates, more particularly, to the use of a geopolymer as defined previously in catalysis or in filtration.

The invention will be better understood on reading the following figures and examples, the objective of which is not to limit the invention in its applications, it is only a question of illustrating here the possibilities offered by this novel development of the art.

### BRIEF DESCRIPTION OF THE DRAWINGS

FIG. 1 presents the pore distribution as a function of the accessibility diameter determined by mercury porosimetry for geopolymers of controlled pore modes.

FIG. 2 presents the pore volume distribution as a function of the accessibility diameter determined by mercury porosimetry for geopolymers of different pore selectivity.

FIG. 3 presents the influence of silica and, more particularly, of its particle size distribution on the distribution of the accessibility diameter determined by mercury porosimetry for geopolymers of controlled pore modes.

### DETAILED DESCRIPTION OF PARTICULAR EMBODIMENTS

### I: Materials Used, Choice of Formulation and Methods

I.1. Aluminosilicate Source

In all of the following examples, the aluminosilicate source used is metakaolin since this aluminosilicate source makes it possible to obtain geopolymers that are more “pure” and for which the properties are overall more homogeneous [39, 40].

The metakaolin used is Pieri Premix MK (Grace Construction Products), the composition of which, determined by X-ray fluorescence, is listed in Table 1. The specific surface area of this material, measured by the Brunauer-Emmett-Teller method, is equal to 19.9 m²/g and the median diameter of the particles (d50), determined by laser particle size analysis, is equal to 5.9 μm.

TABLE 1
Chemical composition of the
metakaolin used.

| Weight % | SiO₂ | Al₂O₃ | CaO₃ | Fe₂O₃ | TiO₂ | K₂O | Na₂O | MgO | P₂O₅ |
|---|---|---|---|---|---|---|---|---|---|
| Metakaolin | 54.40 | 38.4 | 0.10 | 1.27 | 1.60 | 0.62 | <0.20 | <0.20 | / |

I.2. Compensating Cations.

In all of the following examples, the compensating cations used are alkali metals. Specifically, these cases are the most frequently encountered in the literature ([40-42] for example); they therefore constitute a better illustration of the subject.

Moreover, in order to maximize the geopolymerization reactions and to ensure the electroneutrality of the material, the amount of alkali metal introduced into the mixture was set so that the M₂O/Al₂O₃ overall ratio is equal to 1. The alkali metal hydroxide solutions used were prepared by dissolving granules of NaOH, of KOH (Prolabo, Rectapur, 98%) and of CsOH (Alfa Aesar, 99.9%) in ultrapure water.

I.3. Silica.

The silica optionally added to the system is an amorphous silica (BDH), the average diameter of which is equal to 128.81 μm.

I.4. Method of Synthesis.

The mixing of the constituents took place in two steps.

During the first step, the activation solutions containing alkali metal silicates were prepared. The alkali metal hydroxide solutions were obtained by dissolving appropriate products in ultrapure water. The amorphous silica optionally added to the system was then introduced into these solutions and mixed for 30 minutes. The composition of these activation solutions is thus entirely described by:

the natures of the alkali metals used in the formulation and their optional molar ratio;

the H₂O/M₂O molar ratio, denoted by e;

the SiO₂/M₂O molar ratio, denoted by s.

During the second step, the geopolymer was prepared by mixing metakaolin and the activation solution in a standardized laboratory mixer (European Standard EN 196-1) for 1 minute at slow speed and 2 minutes at rapid speed. The material is then placed in Teflon moulds having dimensions of 4×4×16 cm, vibrated for a few seconds, then placed under sealed conditions at 20° C. and at atmospheric pressure for 24 hours. After this period, the geopolymer was demoulded then placed in a sealed bag and stored at ambient pressure and ambient temperature until use.

I.5. Experimental Methods.

The porosity of the geopolymers was characterized by:
the water-accessible porosimetry according to the recommendations of the Association Française pour la Construction (AFPC) [French Construction Association] and of the Association Française de Recherches et d'Essais sur les Matériaux et les Constructions (AFREM) [French Association of Research and Tests on Materials and Constructions], this method of measuring the porosity is one of the most representative of the total porosity of construction materials [43];
mercury intrusion porosimetry. These measurements were carried out on a Micromeritics Autopore IV 9510 machine, the test pressures of which varied from 0.2 to 61000 psi.

### II: Control of the Total Porosity by the Amount of Water

It is possible to control the total porosity of the geopolymers by modifying the formulation parameters of these materials, in particular the water content.

Table 2 summarizes the water porosity measurements carried out on geopolymers of different composition. A small variation in the water content greatly impacts the total porosity measured.

TABLE 2
Composition of the geopolymers and
associated water-accessible porosity.

| Compensating | | | Water-accessible |
|---|---|---|---|
| cation | s | e | porosity (%) |
| K | 1 | 12 | 53.2 |
| K | 1.2 | 12 | 53.6 |
| K | 1.4 | 10 | 47.6 |
| K | 1.2 | 10 | 47.5 |
| Na | 0.6 | 12 | 55.6 |
| Na | 1.2 | 12 | 51.4 |

### III: Control of the Pore Mode by the Amount of Silica

The object here is to formulate two materials having controlled and distinct pore modes: the first material must have a unimodal macroporosity centred about 100 nm, the second geopolymer a unimodal mesoporosity centred about 10 nm.

The two geopolymers were manufactured according to the following formulations:

Compensating cation: sodium only, s=1.2, e=12;

Compensating cation: sodium only, s=0.6, e=12.

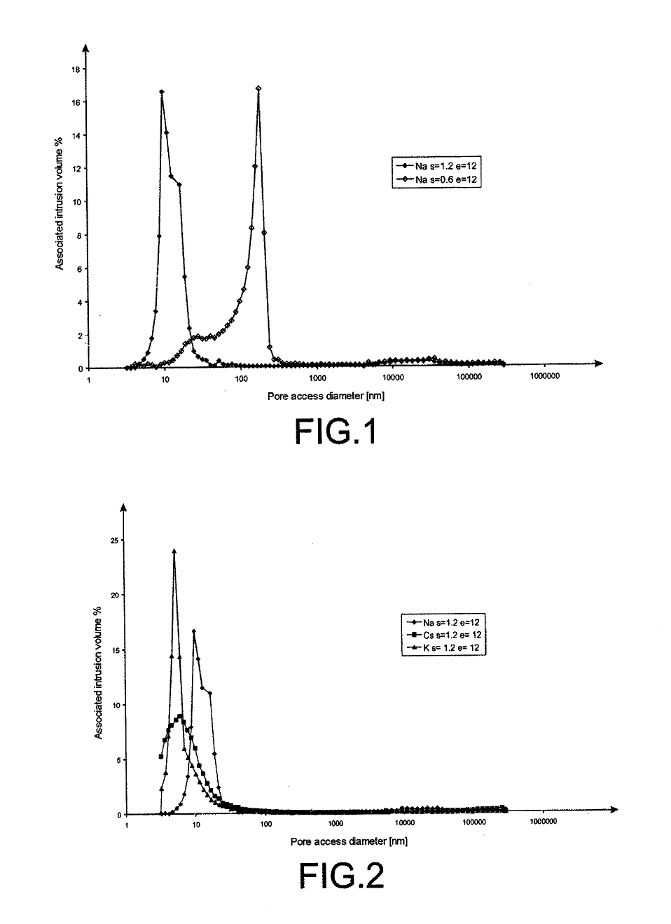

The analyses carried out on these materials by mercury porosimetry (FIG. 1) clearly show that the specifications are fulfilled and that the pore access diameters correspond to the initial constraint.

### IV: Control of the Pore Distribution by the Nature of the Compensating Cation

The objective here is to formulate three materials that have unimodal mesoporosities, the pore volume distribution of which is more or less extensive.

The geopolymers were manufactured according to the following formulations:

Compensating cation: sodium only, s=1.2, e=12;

Compensating cation: potassium only, s=1.2, e=12;

Compensating cation: caesium only, s=1.2, e=12.

The analyses carried out on these two materials by mercury porosimetry (FIG. 2) clearly show that the specifications are fulfilled:

the potassium geopolymer has a unimodal porosity, the distribution of which is highly refined since more than 50% of the pores have an access diameter between 4.7 and 6.1 nm;

the caesium geopolymer also has a single pore mode, but the pore distribution of which is broader than that of the potassium geopolymer: 50% of the pores have an access diameter between 4.1 and 8.8 nm;

the sodium geopolymer, the porosity of which is still unimodal and selective, but the distribution of which is more spread out since the range of pores is of greater size: 50% of the pores have an access diameter between 9.9 and 16.5 nm.

### V: Influence of the Nature of the Optional Silicate Components

The objective here is to study the influence of the silicate components that the activation solution may contain and, more particularly, the influence of the nature of the silica introduced into the activation solution.

Thus, three different types of silica were introduced into the activation solution:
Precipitated silica (BDH), the particle size of which is d10=75.29 μm, d50=128.81 μm, d90=216.18 μm;
Tixosil 331 (precipitated silica from Rhodia Silices), the particle size of which is d10=3.59 μm, d50=9.19 μm, d90=25.02 μm;
Tixosil 38 (precipitated silica from Rhodia Silices), the particle size of which is d10=1.40 μm, d50=3.66 μm, d90=8.79 μm.

The particle sizes were determined by laser particle size analysis.

V.1. Water-Accessible Porosity Results.

Table 3 below compares the values of the total porosities of the geopolymers synthesized with Tixosil 331 and 38 silicas with the porosity of a geopolymer synthesized with a BDH precipitated silica.

The median diameter and the range of the particle size distribution have a significant influence on the water-accessible porosity: the lower the median diameter, the lower the total porosity.

TABLE 3
Influence of the particle size of
the silica on the total porosity of the geopolymers

| | Total porosity in % | | |
|---|---|---|---|
| | BDH | | |
| | precipitated | Tixosil | Tixosil |
| | silica | 331 | 38 |
| K⁺ s = 1.2 e = 10 | 47.5 | 39.4 | 27.3 |
| K⁺ s = 1.2 e = 12 | 53.6 | 42.3 | 36.3 |

V.2. Pore Size Distribution Results.

Table 4 summarizes the formulations of the geopolymers studied.

TABLE 4
Formulation of the geopolymers studied

| Formula | Silica |
|---|---|
| K⁺ s = 1.2 e = 10 | Tixosil 331 |
| K⁺ s = 1.2 e = 10 | Tixosil 38 |
| K⁺ s = 1.2 e = 12 | Tixosil 331 |
| K⁺ s = 1.2 e = 12 | Tixosil 38 |

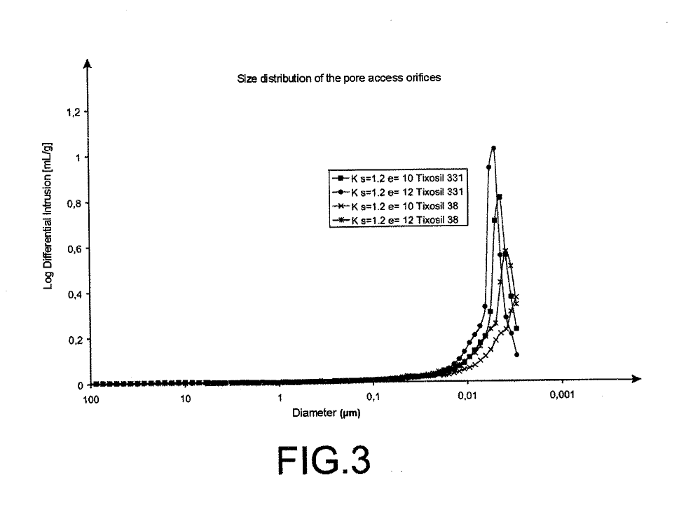

The size distribution of the pore access diameters, obtained by mercury porosimetry, is given in FIG. 3.

The Tixosil 38 silica makes it possible to obtain geopolymers, the pore dispersion of which is centred around smaller values than the Tixosil 331. The Tixosil 38 has a particle size slightly below the Tixosil 331, but that is above all much less dispersed.

It should be emphasized that the porosity obtained is always mesoporous (silica content), and refined (potassium compensating cation): the particle size of the silica therefore mainly influences the water-accessible porosity of the material and the characteristic dimensions of the diameter on which the pore mode is centred.

### CONCLUSION

A judicious formulation of the geopolymers makes it possible to control the macroporosity and/or the mesoporosity of these materials and opens the way for engineering the porosity of these materials, amorphous aluminosilicate inorganic polymers.

The applications of materials of this type, which are easy to process, inexpensive and for which the thermal properties and fire-resistance properties no longer need to be demonstrated, could prove to be multiple in varied industrial sectors using catalytic supports and/or supports for separating chemical species.

### REFERENCES

1. Breck, D. W., Zeolite Molecular Sieves: Structure, Chemistry and Use. 1974, New York: Wiley Interscience. 415-418.
2. Xu, H. and J. S. J. Van Deventer. The Geopolymerisation of Natural Alumino-Silicates. in Geopolymer '99 Proceedings. 1999: p. 43-63.
3. Barbosa, V. F. F., K. J. D. MacKenzie, and C. Thaumaturgo, Synthesis and characterisation of materials based on inorganic polymers of alumina and silica: sodium polysialate polymers. International Journal of Inorganic Materials, 2000. 2(4): p. 309-317.
4. Xu, H. and J. S. J. Van Deventer, Geopolymerisation of multiple minerals. Minerals Engineering, 2002. 15: p. 1131-1139.
5. Davidovits, J., Recent Progresses in Concretes for Nuclear Waste and Uranium Waste Containment. Concrete International, 1994. 16(2): p. 53-58.
6. Palomo, A., M. T. Blanco-Varela, M. L. Granizo, F. Puertas, T. Vazquez, and M. W. Grutzeck, Chemical stability of cementitious materials based on metakaolin. Cement and Concrete Research, 1999. 29(7): p. 997-1004.
7. Palomo, A., M. W. Grutzeck, and M. T. Blanco, Alkali-activated fly ashes: A cement for the future. Cement and Concrete Research, 1999. 29(8): p. 1323-1329.
8. Lee, W. K. W. and J. S. J. Van Deventer, The effects of inorganic salt contamination on the strength and durability of geopolymers. Colloids and Surfaces A: Physicochemical and Engineering Aspects, 2002. 211: p. 115-126.
9. Swanepoel, J. C. and C. A. Strydom, Utilisation of fly ash in a geopolymeric material. Applied Geochemistry, 2002. 17: p. 1143-1148.
10. Hardjito, D., S. E. Wallah, D. M. J. Sumajouw, and B. V. Rangan. Properties of Geopolymer

Concrete with Fly Ash as Source Material: Effect of Mixture Composition. In 7th CANMET/ACI International Conference on Recent Advances in Concrete Technology. 2004. May 26-29, Las Vegas, USA.
11. Bankowski, P., L. Zou, and R. HODGES, Using inorganic polymer to reduce leach rates of metals from brown coal fly ash. Minerals Engineering, 2004. 17: p. 159-166.
12. Bakharev, T., Geopolymeric Materials prepared using Class F fly as hand elevated temperature curing. Cement and Concrete Research, 2005. 35: p. 1224-1232.
13. Xu, H. and J. S. J. van Deventer, The geopolymerisation of alumino-silicate minerals. International Journal of Mineral Processing, 2000. 59: p. 247-266.
14. Barbosa, V. F. F., K. J. D. MacKenzie, and C. Thaumaturgo. Synthesis and Characterization of Sodium Polysialate Inorganic Polymer Based on Alumina and Silica. in Geopolymer '99 Proceedings. 1999: p. 65-77.
15. Davidovits, J. Chemistry of Geopolymeric Systems, Terminology. in Geopolymer '99 Proceedings. 1999: p. 9-39.
16. Skvara, F. and F. Kastanek, Geopolymer binder based on fly ash, SK332004, Editor. 2004.
17. Skvara, F. and A. Allahverdi, Binding geopolmeric mixture., CZ20003781, Editor. 2002.
18. Ikeda, O., Solidification and materialization of fly ash powder with geopolymer, JP8301639, Editor. 1996.
19. Ikeda, O., Solidification and materialization of kaolin powder with geopolymer., JP8301638, Editor. 1996.
20. Comrie, D., Cementitious materials including stainless steel slag and geopolymers, US2005160946, Editor. 2005.
21. Davidovits, J., Producing geopolymer cement free from Portland cement., FR2712882, Editor. 1995.
22. Laney, B., Geopolymer-modified, gypsum-based construction material, AU3031392, Editor. 1994.
23. Johnson, G. B., Geopolymer concrete and method of preparation and casting, EP1689691, Editor. 2006.
24. Davidovits, J. and F. Waendendries, Geopolymer stone for construction and decoration comprises rock residues and a poly(sialate), poly(sialate-siloxo) and/or poly(sialate-disoloxo) geopolymer binder., FR2831905, Editor. 2003.
25. Yan, S., Geopolymer dry powder regenerated polystyrene heat preservation and heat insulating mortar., CN1762884, Editor. 2006.
26. Stein, L. and M. R. Russak, Fire-resistant containers made with geopolymer binder material, WO2004026698, Editor. 2004.
27. Kuenzel, E. and B. Leydolph, Heat-insulating composite material molded part production comprises mixing a high porous granulate based on grain and/or leguminous plant with a geopolymer, molding the mixture into molded body, and hardening., DE10220310, Editor. 2003.
28. Nicholson, C. L. and R. A. Fletcher, Geopolymers and method for their production, WO2005019130, Editor. 2005.
29. Davidovits, J. and R. Davidovits, Ready-to-use liquid geopolymer resins and method for production thereof., WO03087008, Editor. 2003.
30. Vahlbrauk, K., Prefabricated chimney, DE4410437, Editor. 1995.
31. Vahlbrauk, K., Wall, Ceiling or, floor building member., DE1953590, Editor. 1996.
32. Angus, M. D. and I. H. Godfrey, Waste disposal method, WO2006097696, Editor. 2006.
33. Davidovits, J., Method for obtaining a geopolymer binder allowing to stabilize, solidify and consolidate toxic or waste materials., WO9204298, Editor. 1992.
34. Davidovits, J., Method for stabilizing, solidifying and storing waste material., WO8902766, Editor. 1989.
35. Rouquerol, J., D. Avnir, C. W. Fairbridge, D. H. Everett, J. H. Haynes, N. Pernicone, J. D. F. Ramsay, K. S. W. Sing, and K. K. Unger, Recommendations for the characterization of porous solids Pure Appl. Chem., 1994. 66 p. 1739-1758.
36. Barbosa, V. F. F. and K. J. D. MacKenzie, Thermal behaviour of inorganic geopolymers and composites derived from sodium polysialate. Materials Research Bulletin, 2003. 38: p. 319-331.
37. Duxson, P., A. Fernandez-Jimenez, J. L. Provis, G. C. Lukey, A. Palomo, and J. S. J. Van Deventer, Geopolymer technology: the current state of the art. Journal of Materials Science 2007. (in press).
38. McCormick, A. V. and A. T. Bell, The Solution Chemistry of Zeolite Precursors. Catalunya Revue of Science and Engineering, 1989. 31(1-2): p. 97-127.
39. Phair, J. W., J. D. Smith, and J. S. J. Van Deventer, Characteristics of aluminosilicate hydrogels related to commercial <<Geopolymers>> Materials Letters, 2003. 57: p. 4356-4367.
40. Zhang, Y. S., W. Sun, and Z. J. Li, Hydration process of potassium polysialate (K-PSDS) geopolymer cement. Advances in Cement Research, 2005. 17(1): p. 23-28.
41. Palomo, A., S. Alonso, A. Fernandez Jiminez, I. Sobrados, and J. Sanz, Alkaline activation of fly ashes. A NMR study of the reaction products. Journal of American Ceramic Society, 2004. 87(6): p. 1141-1145.
42. Fernandez-Jimenez, A., A. Palomo, and M. Criado, Microstructure development of alkali-activated fly ash cement: a descriptive model. Cement and Concrete Research, 2005. 35(6): p. 1204-1209.
43. AFPC-AFREM, Durabilité des bétons. Méthodes recommandées pour la mesure des grandeurs associées à la durabilité. [Concrete durability. Recommended methods for measuring quantities associated with durability] Compte-rendu des journées techniques. 1997, Toulouse. 283.

1. A method for preparing a controlled porosity geopolymer comprising a step of dissolution/polycondensation of an aluminosilicate source in an activation solution that may optionally contain silicate components, the method comprising the following successive steps:
a. defining at least one characteristic of a porosity of the geopolymer to be prepared;
b. determining a value or an element for at least one parameter chosen from a total amount of water, a total amount of silica, a compensation cation, and a particle size distribution of the optional silicate components, which makes it possible to obtain the characteristic defined in step (a); and
c. selecting said value or said element predetermined in step (b).

2. The preparation method according to claim 1, wherein said step (c) consists of selecting a predetermined value for the total amount of water and/or for the particle size distribution of said silicate components in order to obtain a geopolymer for which a water-accessible porosity is between around 15% and around 65%.

3. The preparation method according to claim 1, wherein the predetermined value for the particle size distribution of said silicate components is chosen from a predetermined value of a median diameter of the particle size distribution of said silicate components or a predetermined value of the range of the particle size distribution of said silicate components.

4. The preparation method according to claim 1, wherein said selection step consists of selecting a predetermined value for a total amount of silica in order to obtain a geopolymer having a unimodal microporosity, mesoporosity or macroporosity.

5. The preparation method according to claim 1, wherein the selection of a total amount of silica with an SiO₂/M₂O molar ratio greater than 1 makes it possible to obtain a geopolymer having a unimodal mesoporosity, M₂O representing the molar amount of compensation cation oxide in the activation solution.

6. The preparation method according to claim 1, wherein the selection of a total amount of silica with an SiO₂/M₂O molar ratio less than 1 makes it possible to obtain a geopolymer having a unimodal macroporosity, M₂O representing the molar amount of compensation cation oxide in the activation solution.

7. The preparation method according to claim 1, wherein the selection step consists of selecting said compensation cation from alkali metals, alkaline-earth metals and mixtures thereof.

8. The preparation method according to claim 1, wherein the selection step consists of selecting a compensation cation from potassium, sodium and caesium in order to obtain a pore distribution of the geopolymer containing potassium as the compensation cation that is less than a pore distribution of the geopolymer containing sodium as the compensation cation, which is itself less than a pore distribution of the geopolymer containing caesium as the compensation cation.

9. The preparation method according to claim 1, wherein said aluminosilicate source is a solid source containing amorphous aluminosilicates.

10. The preparation method according to claim 9, wherein said amorphous aluminosilicates are chosen from natural aluminosilicate minerals, calcined natural aluminosilicate minerals, synthetic glass based on pure aluminosilicates, aluminous cement, pumice, calcined by-products or residues of industrial exploitation and mixtures thereof.

11. The preparation method according to claim 1, wherein said activation solution is a strongly alkaline aqueous solution.

12. The preparation method according to claim 1, wherein said silicate components are:
one or more first silicate(s) introduced in the form of compensation cation silicates;
one or more second silicate(s) added and chosen from silica, colloidal silica and vitreous silica; or
a mixture of said first and second silicates.

13. The preparation method according to claim 1, wherein said activation solution has a pH greater than 9.

14. A geopolymer capable of being prepared by a method as defined in claim 1, wherein said geopolymer has a unimodal mesoporosity with 50% of the pores having an accessibility diameter determined by mercury porosity that extends over less than 5 nm (highly refined pore distribution) or between 5 and 10 nm (broader pore distribution).

15. A geopolymer capable of being prepared by a method as defined in claim 1, wherein said geopolymer has a unimodal macroporosity with 50% of the pores having an accessibility diameter determined by mercury porosity that extends over less than 10 nm (highly refined pore distribution) or between 10 and 50 nm (broader pore distribution).

16. Catalyst support and/or support for separating chemical species comprising a geopolymer according to claim 14.

17. Use of a geopolymer according to claim 14 in catalysis.

18. Use of a geopolymer according to claim 14 in filtration.

19. Catalyst support and/or support for separating chemical species comprising a geopolymer according to claim 15.

20. Use of a geopolymer according to claim 15 in catalysis.

21. Use of a geopolymer according to claim 15 in filtration.

22. The preparation method according to claim 11, wherein said strongly alkaline aqueous solution contains silicate components.
